(19) United States
(12) Patent Application Publication
(10) Pub. No.: US 2008/0129257 A1
(43) Pub. Date: Jun. 5, 2008

(54) PULSE WIDTH MODULATION CONTROLLER

(75) Inventor: Jong-Ping Lee, Hsinchu (TW)

Correspondence Address: J C PATENTS, INC., 4 VENTURE, SUITE 250, IRVINE, CA, 92618, US

(73) Assignee: WINBOND ELECTRONICS CORP., Hsinchu (TW)

(21) Appl. No.: 11/671,817

(22) Filed: Feb. 6, 2007

(30) Foreign Application Priority Data
Dec. 4, 2006 (TW) 95144940

(51) Int. Cl. H02M 3/142

(52) U.S. Cl. 323/271

(57) ABSTRACT

A pulse width modulation (PWM) controller is provided. The PWM controller transfers a conventional enable mechanism integrated into a versatile pin (PH) and integrates it into a feedback pin (FB) of the PWM controller, so as to promote the noise reduction capability of the PWM controller and avoid false operation. Furthermore, the parasitic capacitance of an enable transistor employed in the enable mechanism of the PWM controller does not degrade the accuracy of the over-current protection performed by the PWM controller on an electronic device. Thus, the PWM controller can effectively perform the over-current protection mechanism on the electronic device.

### BACKGROUND OF THE INVENTION

1. Field of the Invention

The present invention relates to a pulse width modulation (PWM) controller. More particularly, the present invention relates to a PWM controller with a plurality of versatile pins.

2. Description of Related Art

Generally speaking, a PWM controller is applied in a voltage converter so as to enable voltage converter to provide a stable output voltage to an electronic device, such as a power supply required by a CPU on a mainboard. FIG. 1 is a circuit diagram of a conventional voltage converter 100. With regard to the architecture of a PWM controller 101 of the voltage converter 100 in FIG. 1, if a user tends to activate the voltage converter 100 to provide a stable output voltage Vout to the electronic device (not shown), the PWM controller 101 will not be enabled until an enable signal Ve is provided to an enable pin EN individually defined by the PWM controller 101.

FIG. 2 is a circuit diagram of a conventional voltage converter 200 integrating the enable pin EN individually defined by the PWM controller 101 in FIG. 1 into other pins of the PWM controller 101. The circuit diagram of the voltage converter 200 in FIG. 2 is a technique disclosed in the ROC Patent Application No. 93120057 and mainly directed to realizing the versatile pin PH of the PWM controller 201. The pin PH may have an enable mechanism, a mechanism of detecting an input voltage Vin and an internal power supply voltage Vcc1 of the voltage converter 200, and a mechanism of over-current protection electronic device, so as to increase the applicability of the pin of the PWM controller and reduce the number of pins for package.

However, in order to achieve the aforementioned object, the voltage converter 200 in FIG. 2 causes a problem that as transistors M2 and M3 are power transistors and a current lout flowing through the pin PH is large, a large noises is generated and fed back to the pin PH, which possibly causes false operation of the PWM controller 201. Besides, the parasitic capacitance of the enable transistor Ml also degrades the accuracy of the over-current protection performed by the PWM controller 201 to the electronic device, thereby possibly damaging the electronic device.

### SUMMARY OF THE INVENTION

Accordingly, the present invention is directed to providing a PWM controller for a voltage converter, wherein the PWM controller is used to provide a stable output voltage to an electronic device. The PWM controller comprises a first output pin, a first versatile pin, a feedback unit and an enable unit. The first output pin is used to output a first output signal. The feedback unit is coupled to the first versatile pin for receiving a feedback signal to control a pulse width of the first output signal output from the first output pin, wherein the feedback signal is generated according to the output voltage. The enable unit is coupled to the first versatile pin for detecting the voltage of the first versatile pin, so as to determine whether the PWM controller is enabled or not.

The PWM controller provided by the present invention transfers an enable mechanism conventionally integrated into a versatile pin (PH) and integrates it into a feedback pin (FB) of the PWM controller, so the feedback pin (FB) of the PWM controller of the present invention does not function on the operation loop of a power transistor, such that noise reduction capability is promoted and false operation of the PWM controller is avoided. Furthermore, as the enable transistor employed by the enable mechanism of the PWM controller of the present invention is not on the loop of the over-current protection electronic device, the parasitic capacitance of the enable transistor does not degrade the accuracy of the over-current protection performed by the PWM controller on the electronic device.

In order to the make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional voltage converter.

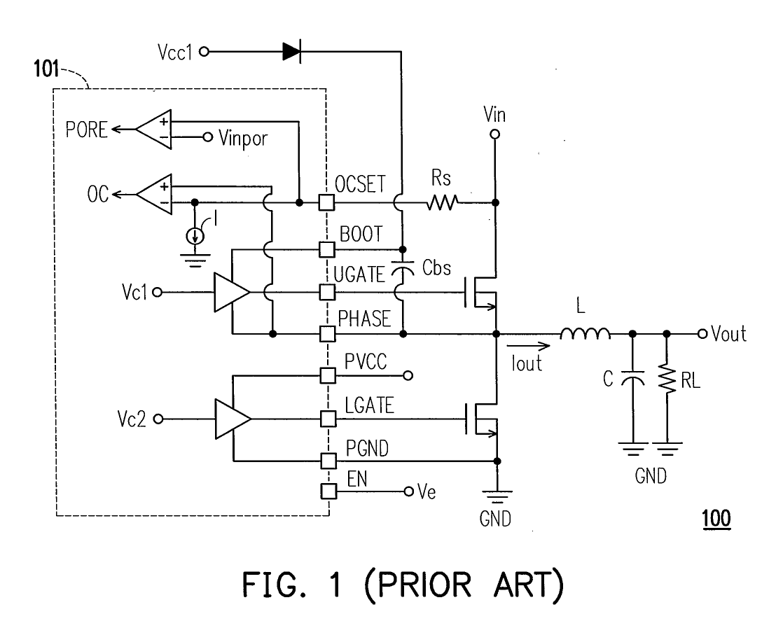

FIG. 2 is a circuit diagram of a conventional voltage converter integrating the enable pin individually defined by the PWM controller in FIG. 1 into other pins.

FIG. 3 is a circuit diagram of a voltage converter according to a preferred embodiment of the present invention.

### DESCRIPTION OF EMBODIMENTS

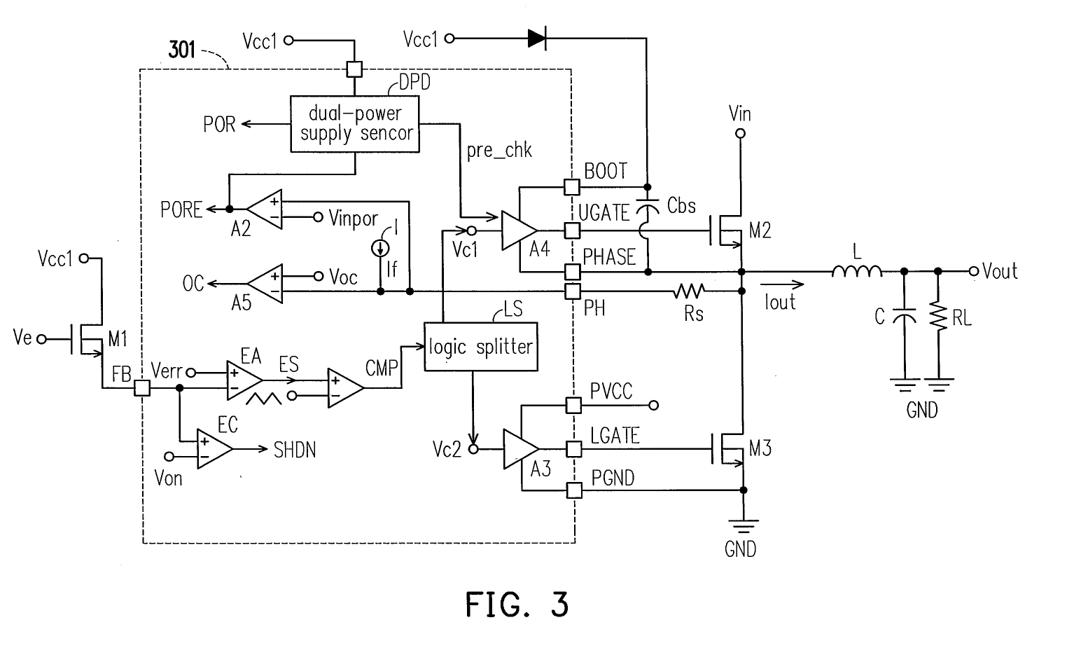

FIG. 3 is a circuit diagram of a voltage converter 300 according to a preferred embodiment of the present invention. The voltage converter 300 in this embodiment has the function of providing a stable output voltage Vout to an electronic device (not shown), such as (but not limited to) a CPU on a mainboard. A PWM controller 301 in this embodiment is not limited to be applied in the field of controlling power supply. That is to say, the electronic devices as long as using a PWM signal all fall in the protection scope claimed in the present invention.

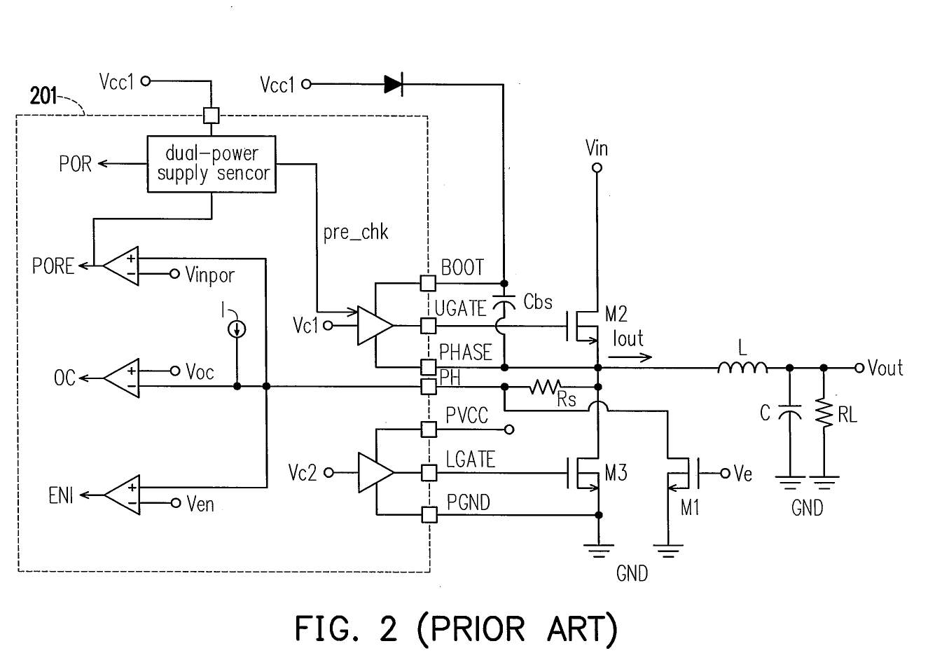

Referring to FIGS. 2 and 3, the main difference between the architecture of the PWM controller 301 in this embodiment and the architecture of the PWM controller 201 as shown in FIG. 2 of the prior art lies in that the PWM controller 201 as shown in FIG. 2 of the prior art integrates the enable mechanism, the mechanism of detecting an input voltage Vin and an internal power supply voltage Vcc1 of the voltage converter 200, and the mechanism of over-current protection electronic device into a pin PH, while the PWM controller 301 in this embodiment maintains the mechanism of detecting an input voltage Vin and an internal power supply voltage Vcc1 of the voltage converter 300 and the mechanism of over-current protection electronic device and integrates them into the pin PH, and transfers and integrates the enable mechanism into a feedback pin (FB).

Firstly, the circuit operation flows of two mechanisms related to the first versatile pin FB are explained. In the PWM controller 301 in this embodiment, two units are coupled to the versatile pin FB, in which one is an enable unit, and the other is a feedback unit. The enable unit is used to detect the voltage state of the versatile pin FB, so as to enable the PWM controller. In this embodiment, the enable unit is composed of an enable switch M1 (such as an NMOS transistor) and an enable comparator EC, wherein the enable switch M1 is controlled by an enable signal Ve, and when the enable signal Ve is at a high potential, the enable switch M1 is turned on and the voltage level of the versatile pin FB is raised to be the voltage level of the internal power supply voltage Vcc1 of the PWM controller 301.

Then, as the voltage level of the versatile pin FB is equal to the voltage level of the power supply voltage Vcc1 at this time, the voltage level of a positive input end (+) of the enable comparator EC is also equal to the voltage level of the power supply voltage Vcc1, and is then compared with an enable reference voltage Von predetermined at a negative input end (−), so as to determine whether the PWM controller 301 is enabled or not. That is to say, when an output end of the enable comparator EC is activated, namely, an output signal SHDN is output; it indicates that the PWM controller 301 is in an enable state. Otherwise, when the output end of the enable comparator EC is not activated, namely, the output signal SHDN is not output, it indicates that the PWM controller 301 is in a disabled state.

The feedback unit receives a feedback signal, and controls the pulse widths of a first output signal Vc1 and a second output signal Vc2 respectively output from a first output pin UGATE and a second output pin LGATE of the PWM controller 301 according to the feedback signal. The feedback signal is generated according to the output voltage Vout provided by the voltage converter 300 to the electronic device, and the phase difference between the first output signal and the second output signal respectively output from the first output pin UGATE and the second output pin LGATE of the PWM controller 301 is 180 degrees, namely, the first output signal and the second output signal are opposite in phase. It is well known that the feedback unit is mainly used to provide a stable operation of the overall PWM controller 301.

In this embodiment, the feedback unit is composed of an error amplifier EA, a feedback comparator CMP and a logic splitter LS. A negative input end (−) of the error amplifier EA, after receiving the feedback signal, compares the feedback signal with an error reference voltage Verr predetermined at a positive input end (+), and compensates and outputs an error signal ES to a positive input end (+) of the feedback comparator CMP.

Next, the feedback comparator CMP compares the error signal ES received at the positive input end (+) with a triangular wave signal received at a negative input end (−), and then modulates it into a PWM signal to be output to the logic splitter LS. The logic splitter LS receives the PWM signal output from the feedback comparator CMP and converts it into the first output signal Vc1 and the second output signal Vc2 which are opposite in phase and output to corresponding gate drivers A4 and A3, respectively, so as to be respectively output from the first output pin UGATE and the second output pin LGATE of the PWM controller 301 and switch the power transistors M2 and M3.

Additionally, the circuit operation flows of two mechanisms related to the second versatile pin PH are explained. In the PWM controller 301 in this embodiment, two units are coupled to the versatile pin PH, in which one is a power supply sensing unit, and the other is an over-current protection unit. The power supply sensing unit is used to sense the voltage of the versatile pin PH and the power supply voltage Vcc1 inside the PWM controller 301, so as to determine whether the input voltage Vin of the voltage converter 300 and the power supply voltage Vcc1 inside the PWM controller 301 are activated or not.

In this embodiment, the power supply sensing unit is composed of a power supply comparator A2 and a dual-power supply sensor DPD, wherein the dual-power supply sensor DPD is used to sense the power supply voltage Vcc1 inside the PWM controller 301 to determine whether the PWM controller 301 is activated or not and also to determine whether the input voltage Vin of the voltage converter 300 is activated or not according to a power supply comparison signal PORE output from the power supply comparator A2. When the dual-power supply sensor DPD in this embodiment senses the power supply voltage Vcc1 inside the PWM controller 301, the dual-power supply sensor DPD also outputs a confirmation signal pre_chk to the gate driver A4, so as to turn on the power transistor M2. At this time, the power supply comparator A2 receives the voltage level of the versatile pin PH with its positive input end (+), and then compares it with a power supply reference voltage Vinpor predetermined at the negative input end (−) of the power supply comparator A2, so as to determine whether to generate a power supply comparison signal PORE to the dual-power supply sensor DPD or not.

As described above, when the voltage level of the versatile pin PH is higher than or equal to the power supply reference voltage Vinpor, the output end of the power supply comparator A2 is activated, namely, the power supply comparison signal PORE is output, indicating that the input voltage Vin of the voltage converter 300 is activated. Otherwise, it indicates that the input voltage Vin of the voltage converter 300 is not activated.

Then, when the dual-power supply sensor DPD senses that the power supply voltage Vcc1 inside the PWM controller 301 is also activated, the dual-power supply sensor DPD outputs a signal POR, such that the feedback unit of the PWM controller 301 generates the first output signal Vc1 and the second output signal Vc2, and the power transistors M2 and M3 are switched through the gate drivers A4 and A3, respectively. As a result, an output current lout is generated at the versatile pin PH, so as to provide an output voltage Vout (i.e., the result of multiplying the output current Iout by a load RL of the voltage converter 300) to the electronic device.

In this embodiment, the over-current protection unit is used to detect the voltage level of the versatile pin PH, so as to prevent the output current Jout output from the versatile pin PH being too large and damaging the electronic device. In this embodiment, the over-current protection unit is composed of a current source I and an over-current comparator A5, wherein the current source I provides a constant current If to the versatile pin PH and a negative input end (−) of the over-current comparator A5, and a positive input end (+) of the over-current comparator A5 receives an over-current reference voltage Voc. Therefore, when the voltage level (i.e., the result of multiplying the current If by the resistance Rs) of the versatile pin PH is lower than the over-current reference voltage Voc, it indicates that the output current lout output from the versatile pin PH is too large, and the output end of the over-current comparator A5 outputs an over-current comparison signal OC to make the feedback unit of the PWM controller 301 stop switching the power transistors M2 and M3, thereby stopping the operation of switching the power transistors M2 and M3 to protect the electronic device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pulse width modulation (PWM) controller for a voltage converter, wherein the voltage converter is used to provide a stable output voltage to an electronic device, the PWM controller comprising:
a first output pin, for outputting a first output signal;
a first versatile pin;
a feedback unit, coupled to the first versatile pin, for receiving a feedback signal and controlling a pulse width of the first output signal accordingly, wherein the feedback signal is generated according to the output voltage; and
an enable unit, coupled to the first versatile pin, for detecting a voltage of the first versatile pin, so as to determine whether the PWM controller is enabled or not.

2. The PWM controller as claimed in claim 1, further comprising:
a second versatile pin;
a power supply sensing unit, coupled to the second versatile pin, for sensing a voltage of the second versatile pin and a power supply voltage inside the PWM controller, so as to determine whether an input voltage of the voltage converter and the power supply voltage are activated or not; and
an over-current protection unit, coupled to the second versatile pin, for detecting the voltage of the second versatile pin, so as to prevent an over current output from the second versatile pin.

3. The PWM controller as claimed in claim 1, further comprising a second output pin, for outputting a second output signal, wherein a phase difference between the second output signal and the first output signal is 180 degrees.

4. The PWM controller as claimed in claim 2, wherein the enable unit comprises:
an enable switch, coupled between the power supply voltage and the first versatile pin, and which controlled by an enable signal; and
an enable comparator, for comparing the voltage of the first versatile pin with an enable reference voltage, so as to determine whether the PWM controller is enabled or not.

5. The PWM controller as claimed in claim 1, wherein the feedback unit comprises:
an error amplifier, for comparing the feedback signal with an error reference voltage, so as to output an error signal;
a feedback comparator, for comparing the error signal with a triangular wave signal, so as to modulate into be a PWM signal; and
a logic splitter, for converting the PWM signal into the first output signal and the second output signal.

6. The PWM controller as claimed in claim 2, wherein the power supply sensing unit comprises:
a power supply comparator, for comparing the voltage of the second versatile pin with a reference power supply voltage, so as to generate a power supply comparison signal; and
a dual-power supply sensor, for sensing the power supply voltage to determine whether the power supply voltage is activated or not and to determine whether the input voltage is activated or not according to the power supply comparison signal.

7. The PWM controller as claimed in claim 2, wherein the over-current protection unit comprises:
a current source, for providing a constant current to the second versatile pin; and
an over-current comparator, for comparing the voltage of the second versatile pin with an over-current reference voltage, so as to prevent the over current output from the second versatile pin.
